(19) United States
(12) Patent Application Publication
(10) Pub. No.: US 2012/0019516 A1
(43) Pub. Date: Jan. 26, 2012

(54) MULTI-VIEW DISPLAY SYSTEM AND METHOD USING COLOR CONSISTENT SELECTIVE SUB-PIXEL RENDERING

(75) Inventors: Ju Yong PARK, Seoul (KR); Dong Kyung Nam, Yongin-si (KR); Gee Young Sung, Suseong-gu (KR); Yun Tae Kim, Hwaseong-si (KR)

(73) Assignee: Samsung Electronics Co., Ltd., Suwon-si (KR)

(21) Appl. No.: 13/029,530

(22) Filed: Feb. 17, 2011

(30) Foreign Application Priority Data
Jul. 26, 2010 (KR) 10-2010-0071916

(51) Int. Cl. G06T 15/00

(52) U.S. Cl. 345/419

(57) ABSTRACT

A multi-view display system and method using color consistent selective sub-pixel rendering are provided. The multi-view display system may determine a pixel value based on a contribution level of a viewpoint varying based on a viewing position.

### CROSS-REFERENCE TO RELATED APPLICATIONS

This application claims the priority benefit of Korean Patent Application No. 10-2010-0071916, filed on Jul. 26, 2010, in the Korean Intellectual Property Office, the disclosure of which is incorporated herein by reference.

### BACKGROUND

1. Field

Example embodiments of the following description relate to a multi-view display system and method using color consistent selective sub-pixel rendering.

2. Description of the Related Art

To effectively implement a three-dimensional (3D) image, images having viewpoints different from each other may typically need to be respectively viewed by left/right eyes of human beings. To implement this 3D image without using a filter such as a glass, the 3D image may need to be spatially divided based on the viewpoints, which are referred to as an autostereoscopic display.

In the autostereoscopic display, an image may be spatially divided using an optical device, and displayed. Here, as the optical device, optical lenses or an optical barrier may be representatively used. As an optical device, a lenticular lens may be used by which respective pixel images are displayed only in a predetermined direction. In addition, using the optical barrier, only a predetermined pixel may be viewed from a predetermined direction due to a slit disposed in a front surface of a display.

In a case of the autostereoscopic display using the lenses or the barrier, left/right viewpoint images, that is, two viewpoint images may be basically displayed, resulting in creation of a sweet spot having a significantly narrow width. The sweet spot may be expressed using a viewing distance and a viewing angle. Here, the viewing distance may be determined by a pitch of lenses or a slit, and the viewing angle may be determined by a number of expressible viewpoints. In this instance, a scheme of increasing the number of expressible viewpoints to widen the viewing angle may be referred to as an autostereoscopic multi-view display.

Accordingly, there is a desire for a multi-view display system and method that may more effectively provide a 3D image.

### SUMMARY

The foregoing and/or other aspects are achieved by providing a multi-view display system including a contribution level providing unit to provide a contribution level for each of a plurality of viewpoints, and a pixel value determining unit to determine a pixel value of a sub-pixel based on the provided contribution level. Here, the contribution level may be determined based on a viewing position of a user.

The contribution level providing unit may calculate the contribution level based on an intensity of a signal for each of the plurality of viewpoints varying based on the viewing position.

Contribution levels of viewpoints other than a viewpoint that is used in color representing in the viewing position among the plurality of viewpoints may have values less than a predetermined value.

The pixel value determining unit may determine the pixel value of the sub-pixel based on a contribution level of a central viewpoint of the sub-pixel and a contribution level of a central viewpoint of another sub-pixel that represents the same color as a color represented by the sub-pixel.

The same number of sub-pixels as a number of the plurality of viewpoints may form a unit block used to represent a single point of an image, and different viewpoints may be used as central viewpoints of all the sub-pixels in the unit block.

The viewing position may be determined based on a sensing result of a sensor tracking a position of eyes of the user.

The foregoing and/or other aspects are achieved by providing a multi-view display method including providing a contribution level for each of a plurality of viewpoints, and determining a pixel value of a sub-pixel based on the provided contribution level. Here, the contribution level may be determined based on a viewing position of a user.

Additional aspects, features, and/or advantages of example embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the example embodiments, taken in conjunction with the accompanying drawings of which:

FIG. 1 illustrates a diagram of a 4-view pixel rendering according to example embodiments;

FIG. 2 illustrates a diagram of a 12-view sub-pixel rendering according to example embodiments;

FIG. 3 illustrates a graph of a brightness distribution for each viewpoint based on a viewing position according to example embodiments;

FIG. 4 illustrates a graph of a brightness distribution for each viewpoint based on a viewing position determined based on a position of both eyes of a user according to example embodiments;

FIG. 5 illustrates a block diagram of a multi-view display system according to example embodiments; and

FIG. 6 illustrates a flowchart of a multi-view display method according to example embodiments.

### DETAILED DESCRIPTION

Reference will now be made in detail to example embodiments, examples of which are illustrated in the accompanying drawings, wherein like reference numerals refer to the like elements throughout. Example embodiments are described below to explain the present disclosure by referring to the figures.

A viewpoint image to be provided through a multi-view display may be displayed for each pixel unit, or for each sub-pixel unit. Here, the sub-pixel unit may be a minimal image display unit having a single piece of color information (for example, a unit to indicate each of red (R), green (G), and blue (B) in an RGB color space), and the pixel unit may be a minimal image display unit to express complete color information obtained by joining sub-pixels together (for example, R, G, and B sub-pixels being collectively considered together to be the single pixel).

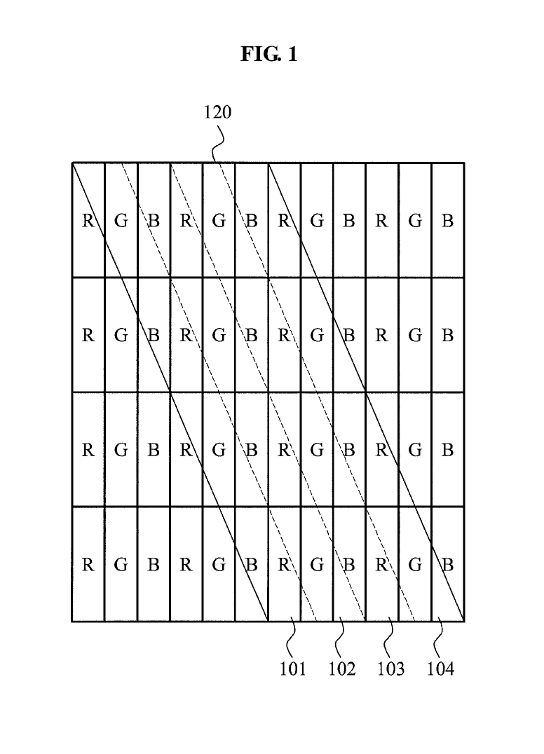

FIG. 1 illustrates a 4-view pixel rendering according to example embodiments. In FIG. 1, a plurality of rectangles may respectively indicate a plurality of sub-pixels, and the sub-pixels may be collected (combined) to form a single display. Additionally, “R”, “G”, and “B” in the rectangles may respectively indicate red, green, and blue in the RGB color space.

In FIG. 1, solid lines and dotted lines may schematically indicate lenses inclined on the display. For example, lenticular lenses may be used as the lenses. Here, a distance between the lines may indicate a pitch of the lenses.

Additionally, two spaces formed between the solid lines and the dotted lines, and two spaces formed among the dotted lines may respectively correspond to four viewpoints, for example a first viewpoint 101, a second viewpoint 102, a third viewpoint 103, and a fourth viewpoint 104, as shown in FIG. 1.

Specifically, FIG. 1 illustrates sub-pixels and lenses for the 4-view pixel rendering in a display with four viewpoints. A pixel rendering may include a scheme of performing rending to display a single viewpoint image using all three types of sub-pixels, namely, an R sub-pixel, a G sub-pixel, and a B sub-pixel. Here, each of the first viewpoint 101 through the fourth viewpoint 104 of FIG. 1 may be represented as a central viewpoint of each of the R, G, and B sub-pixels. Additionally, a single sub-pixel may have influence on a plurality of viewpoints. For example, among sub-pixels representing the third viewpoint 103 as central viewpoints, a G sub-pixel 120 may be used to express a green color component, and may have influence on the second viewpoint 102 and the fourth viewpoint 104, in addition to the third viewpoint 103, as shown in FIG. 1. In other words, the G sub-pixel 120 may be used to represent the second viewpoint 102 through the fourth viewpoint 104.

In such a pixel rendering, a single viewpoint image may be displayed for each pixel unit. In other words, the R, G, and B sub-pixels of FIG. 1 may be collected to form a single pixel, and a single viewpoint may be represented by a combination of the R, G, and B sub-pixels.

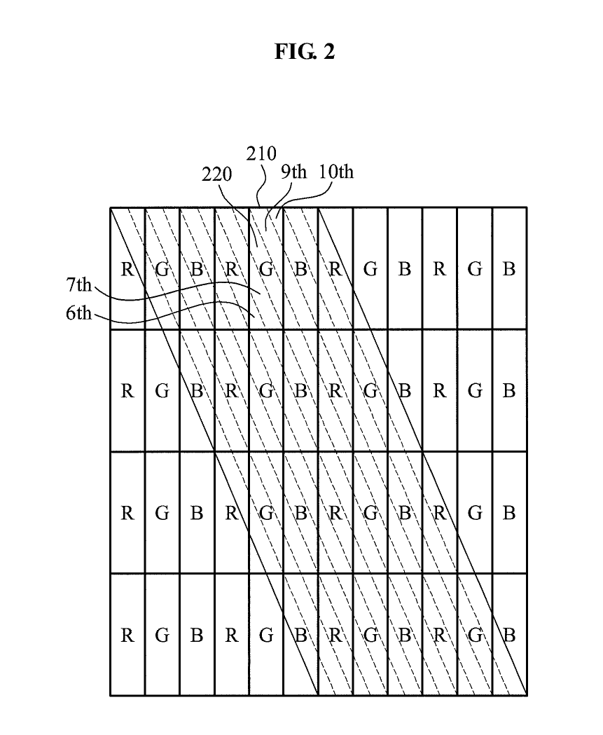

FIG. 2 illustrates a 12-view sub-pixel rendering according to example embodiments. Specifically, FIG. 2 illustrates sub-pixels and lenses for the 12-view sub-pixel rendering in a display with 12 viewpoints. A sub-pixel rendering may include a scheme of performing rendering to display a single viewpoint image using a single sub-pixel, namely an R sub-pixel, a G sub-pixel, or a B sub-pixel. In other words, each of the 12 viewpoints of FIG. 2 may be represented as a central viewpoint of each of R, G, and B sub-pixels. For example, an eighth viewpoint 220 may be represented as a central viewpoint of a G sub-pixel 210, as shown in FIG. 2. In this example, the G sub-pixel 210 may have influence on some viewpoints other than eighth viewpoint. Specifically, the G sub-pixel 210 may have influence on five viewpoints, for example a sixth viewpoint through a tenth viewpoint. In other words, the G sub-pixel 210 may be used to represent the five viewpoints.

In such a sub-pixel rendering, a single viewpoint image may be displayed for each sub-pixel unit. In other words, each of the R, G, and B sub-pixels of FIG. 2 may be used to represent a single viewpoint.

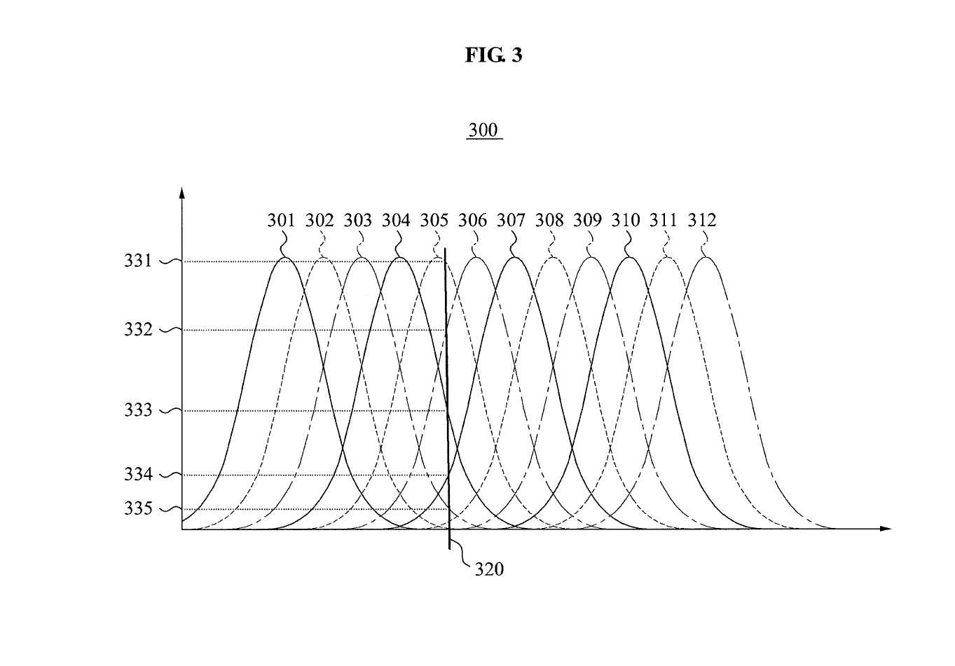

FIG. 3 illustrates a graph 300 of a brightness distribution for each viewpoint based on a viewing position according to example embodiments. In the graph 300 of FIG. 3, an x-axis may indicate a viewing position, and a y-axis may indicate an intensity of a signal for each viewpoint. For example, the intensity of the signal may be based on the brightness. Here, the intensity of the signal may indicate a generalized brightness value.

In FIG. 3, a first curve 301 through a twelfth curve 312 may respectively indicate brightness values of the 12 viewpoints for each viewing position. Among the first curve 301 through the twelfth curve 312, a solid curve may indicate a viewpoint represented as a central viewpoint by a B sub-pixel, and a dotted curve may indicate a viewpoint represented as a central viewpoint by a G sub-pixel. Additionally, a dashed-dotted curve may indicate a viewpoint represented as a central viewpoint by an R sub-pixel. Here, the B sub-pixel may be used to express a blue color component, and the R sub-pixel may be used to express a red color component.

In a display apparatus using a lenticular lens, a brightness of a single viewpoint may have influence on neighboring viewpoints, and as farther from the center, a brightness may be reduced and thus, a crosstalk may be generated. In each of the first curve 301 through the twelfth curve 312, a position with a greatest intensity of a signal may be set as an optimal viewing position. Here, as farther from the optimal viewing position, the intensity of the signal may be reduced. When considering sub-pixels, since it is difficult to ignore an influence of a single viewpoint image on viewing positions for neighboring viewpoints, R, G, and B components may be expressed based on the influence. In other words, a pixel value of a sub-pixel in a viewpoint may be determined using neighboring viewpoints.

Specifically, in a multi-view display system according to example embodiments, an intensity of a signal in a point where a first straight line 320 indicating a single viewing position intersects each of the first curve 301 through the twelfth curve 312 may be used as a contribution level of a viewpoint indicated by a corresponding curve, so that a pixel value may be determined based on the contribution level.

The first straight line 320 of FIG. 3 may intersect the first curve 301 through the twelfth curve 312 in seven points. More precisely, the first straight line 320 may intersect a fifth curve 305, a sixth curve 306, a fourth curve 304, a seventh curve 307, a third curve 303, an eighth curve 308, and a second curve 302, from top to bottom of the graph 300. Here, each value of an intensity of a signal based on the seven points may be used as a contribution level of a viewpoint indicated by a corresponding curve.

FIG. 3 illustrates only five signal intensities, namely, a first signal intensity 331 through a fifth signal intensity 335 from top to bottom of the graph 300. Here, when a sub-pixel rendering is performed based on only the first signal intensity 331, a second signal intensity 332, and a third signal intensity 333, colors may be distorted due to a difference in a contribution level. The colors may be distorted, because the sub-pixel rendering is performed by ignoring a fourth signal intensity 334 corresponding to the seventh curve 307, the fifth signal intensity 335 corresponding to the third curve 303 and the like, even though viewpoints indicated by the seventh curve 307 and the third curve 303 contribute to color representing.

Accordingly, a pixel value may be determined based on a contribution level of each viewpoint and thus, it is possible to reduce color distortion. For example, a value of a B component desired to be expressed may be determined using a B component in a viewpoint indicated by the fourth curve 304, and a B component in a viewpoint indicated by the seventh curve 307. Additionally, viewpoints indicated by the fifth curve 305 and the sixth curve 306 may match a G component and an R component to a determined level of the B component and accordingly, rendering may be performed on a viewpoint image that color distortion is corrected. Thus, it is possible to display an image with little color distortion even in a viewing position other than the optimal viewing position.

Here, a contribution level of a viewpoint that is not used in color representing in the viewing position may have a value less than a predetermined value. For example, contribution levels of viewpoints indicated by the first curve 301, and a ninth curve 309 through the twelfth curve 312 that are not used in the viewing position indicated by the first straight line 320 may be set to be “0”, to prevent the viewpoints from being used to display a viewing image.

Additionally, contribution levels may be classified according to color of sub-pixels, and the classified contribution levels may be used. For example, in the viewing position indicated by the first straight line 320, a contribution level of a viewpoint represented as a central viewpoint by an R sub-pixel may be calculated based on the fourth signal intensity 334 and the fifth signal intensity 335.

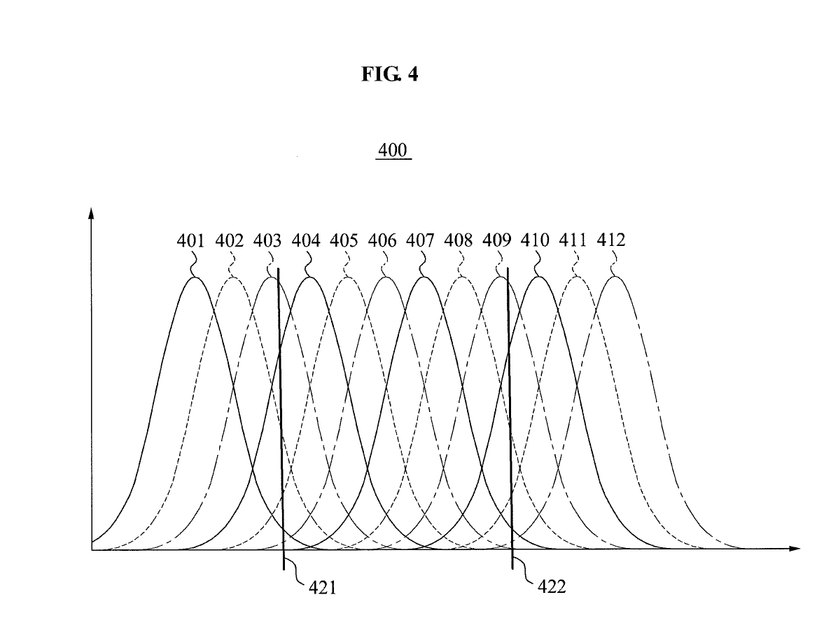

FIG. 4 illustrates a graph 400 of a brightness distribution for each viewpoint based on a viewing position determined based on a position of both eyes of a user according to example embodiments. Similarly to the graph 300 of FIG. 3, in the graph 400, an x-axis may indicate a viewing position, and a y-axis may indicate an intensity of a signal for each viewpoint. In FIG. 4, a first straight line 421, and a second straight line 422 may indicate viewing positions based on the position of both eyes of the user, respectively.

Here, it is assumed that a contribution level of a viewpoint ‘n’ in a single viewing position ‘xₘ’ may be calculated by the below Equation 1. Assuming that there are viewing positions ‘x₁’ to ‘xₘ’, ‘m’ may be a number from ‘1’ to ‘M’.

P_{n,m}=Iₙ(xₘ) Equation 1

In Equation 1, denotes the contribution level of the viewpoint ‘n’, and ‘Iₙ’ denotes an intensity of a signal for the viewpoint ‘n’ in the viewing position ‘xₘ’. In other words, the intensity of the signal for the viewpoint ‘n’ in the viewing position ‘xₘ’ may be used as the contribution level of the viewpoint ‘n’.

Since a single viewing position may be influenced by multiple viewpoints, pixel values of sub-pixels to represent a desired color may be calculated by the below Equation 2.

$$( \begin{matrix}0 & 0 & {p}_{3 , m} & 0 & 0 & {p}_{6 , m} & 0 & 0 & {p}_{9 , m} & 0 & 0 & {p}_{12 , m} \\ 0 & {p}_{2 , m} & 0 & 0 & {p}_{5 , m} & 0 & 0 & {p}_{8 , m} & 0 & 0 & {p}_{11 , m} & 0 \\ {p}_{1 , m} & 0 & 0 & {p}_{4 , m} & 0 & 0 & {p}_{7 , m} & 0 & 0 & {p}_{10 , m} & 0 & 0\end{matrix} ) ( \begin{matrix}{v}_{1} \\ ⋮ \\ {v}_{12}\end{matrix} ) = ( \begin{matrix}{r}_{m} \\ {g}_{m} \\ {b}_{m}\end{matrix} ) \qquad Equation 2$$

Equation 2 may be an example of determining a pixel value of a sub-pixel in a single viewing position in a sub-pixel rendering with 12 viewpoints. In Equation 2, ‘rₘ’, ‘gₘ’, and ‘bₘ’ respectively denote R, G, and B values of a color desired to be expressed in the single viewing position, and ‘ν₁’ through ‘ν₁₂’ denote pixel values of sub-pixels for each of the 12 viewpoints. Each of the pixel values of the sub-pixels may be expressed using analog values from ‘0’ to ‘1’, instead of digital values of ‘0’ to ‘255’. After calculation of the Equation 2, the analog values may be converted into digital values using a gamma function, and may be applied.

Additionally, Equation 2 may be briefly expressed by the below Equation 3.

P_{M}ν=cₘ Equation 3

Pixel values of sub-pixels to represent a desired color in all the viewing positions ‘x₁’ through ‘xₘ’ may be calculated by the below Equation 4:

$$( \begin{matrix}{P}_{1} \\ ⋮ \\ {P}_{M}\end{matrix} ) v = ( \begin{matrix}{c}_{1} \\ ⋮ \\ {c}_{M}\end{matrix} ) \qquad Equation 4$$

Equation 4 may be briefly expressed by the below Equation 5.

Pν=c Equation 5

Here, ‘ν’ denoting each of the pixel values of the sub-pixels in Equation 5 may be expressed by the below Equation 6. In an example, a pixel value of a sub-pixel may be determined based on the contribution level using the below Equation 6.

ν=P^{T}(PP^{T})⁻¹c Equation 6

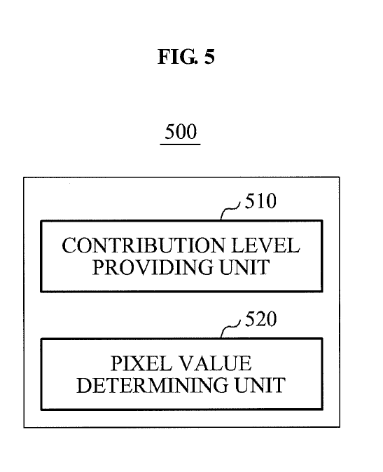

FIG. 5 illustrates a block diagram of a multi-view display system 500 according to example embodiments. The multi-view display system 500 may include a contribution level providing unit 510, and a pixel value determining unit 520, as shown in FIG. 5.

The multi-view display system 500 may perform sub-pixel rendering. To perform the sub-pixel rendering, the same number of sub-pixels as a number of a plurality of viewpoints may form a unit block used to represent a single point of an image. Additionally, different viewpoints may be used as central viewpoints of all the sub-pixels in the unit block. In other words, a unit block may be formed so that a single sub-pixel may be matched to a single viewpoint.

Additionally, the multi-view display system 500 may perform sub-pixel rendering based on a viewing position of a user. Here, the viewing position may be determined based on a sensing result of a sensor tracking a position of eyes of the user.

The contribution level providing unit 510 may provide a contribution level for each of a plurality of viewpoints. Here, the contribution level may be determined based on the viewing position of the user. For example, the contribution level providing unit 510 may calculate the contribution level based on an intensity of a signal for each of the plurality of viewpoints varying based on the viewing position. That is, the contribution level may indicate a level that each viewpoint contributes to color representing in the viewing position.

Additionally, a contribution level of a viewpoint that is not used in the color representing in the viewing position among the plurality of viewpoints may have a value less than a predetermined value. For example, the contribution level of the viewpoint that is not used in the color representing may be set to be a value of “0”. In other words, a viewpoint image corresponding to a non-viewed viewpoint or a non-viewed sub-pixel may not be displayed.

The pixel value determining unit 520 may determine a pixel value of a sub-pixel based on the provided contribution level. Here, the pixel value determining unit 520 may determine the pixel value of the sub-pixel based on a contribution level of a central viewpoint of the sub-pixel and a contribution level of a central viewpoint of another sub-pixel that represents the same color as a color represented by the sub-pixel. For example, contribution levels of viewpoints represented as central viewpoints by G sub-pixels among viewpoints that have influence on the viewing position may be used to determine a pixel value of a G sub-pixel. Additionally, a pixel value of an R sub-pixel and a pixel value of a B sub-pixel may be determined in the same manner as the pixel value of the G sub-pixel.

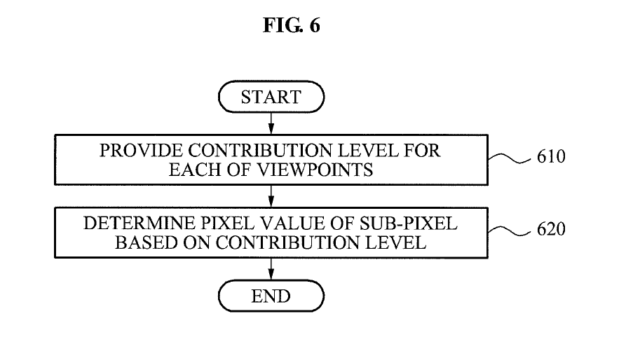

FIG. 6 illustrates a flowchart of a multi-view display method according to example embodiments. The multi-view display method according to example embodiments may be performed by the multi-view display system 500 of FIG. 5.

The multi-view display method may include sub-pixel rendering. To perform the sub-pixel rendering, the same number of sub-pixels as a number of a plurality of viewpoints may form a unit block used to represent a single point of an image. Additionally, different viewpoints may be used as central viewpoints of all the sub-pixels in the unit block. In other words, a unit block may be formed so that a single sub-pixel may be matched to a single viewpoint.

Additionally, the multi-view display method may include sub-pixel rendering based on a viewing position of a user. Here, the viewing position may be determined based on a sensing result of a sensor tracking a position of eyes of the user.

In operation 610, the multi-view display system 500 may provide a contribution level for each of a plurality of viewpoints. Here, the contribution level may be determined based on the viewing position of the user. For example, the multi-view display system 500 may calculate the contribution level based on an intensity of a signal for each of the plurality of viewpoints varying based on the viewing position. That is, the contribution level may indicate a level that each viewpoint contributes to color representing in the viewing position.

Additionally, a contribution level of a viewpoint that is not used in the color representing in the viewing position among the plurality of viewpoints may have a value less than a predetermined value. For example, the contribution level of the viewpoint that is not used in the color representing may be set to be a value of “0”. In other words, a viewpoint image corresponding to a non-viewed viewpoint or a non-viewed sub-pixel may not be displayed.

In operation 620, the multi-view display system 500 may determine a pixel value of a sub-pixel based on the provided contribution level. Here, the multi-view display system 500 may determine the pixel value of the sub-pixel based on a contribution level of a central viewpoint of the sub-pixel and a contribution level of a central viewpoint of another sub-pixel that represents a same color as a color represented by the sub-pixel. For example, contribution levels of viewpoints represented as central viewpoints by G sub-pixels among viewpoints that have influence on the viewing position may be used to determine a pixel value of a G sub-pixel. Additionally, a pixel value of an R sub-pixel and a pixel value of a B sub-pixel may be determined in the same manner as the pixel value of the G sub-pixel.

Most of the multi-view display system and method have already been described and hence, repeated descriptions of FIGS. 5 and 6 are deemed redundant, and accordingly, will be omitted.

As described above, according to example embodiments, through a sub-pixel rendering, a disparity between motion parallaxes may be narrowed, and a pixel value may be determined based on a contribution level of a viewpoint corresponding to a viewing position of a user. Thus, it is possible to reduce a color distortion, and to determine a pixel value of a sub-pixel that is not related to the viewing position, to be a value less than a predetermined value.

The methods according to the above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on a computer hardware media, e.g., a non-transitory or persistent computer-readable medium. The program/software implementing the embodiments may also be transmitted over a transmission communication path, e.g., a network-implemented via hardware. Examples of the non-transitory or persistent computer-readable media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. The described hardware devices may be configured to act as one or more software modules in order to perform the operations of the above-described example embodiments, or vice versa.

Although example embodiments have been shown and described, it would be appreciated by those skilled in the art that changes may be made in these example embodiments without departing from the principles and spirit of the disclosure, the scope of which is defined in the claims and their equivalents.

What is claimed is:

1. A multi-view display system, comprising:
a contribution level providing unit to provide a contribution level for each of a plurality of viewpoints; and
a pixel value determining unit to determine a pixel value of a sub-pixel based on the provided contribution level,
wherein the contribution level is determined based on a viewing position of a user.

2. The multi-view display system of claim 1, wherein the contribution level providing unit calculates the contribution level based on an intensity of a signal for each of the plurality of viewpoints varying based on the viewing position.

3. The multi-view display system of claim 1, wherein contribution levels of viewpoints other than a viewpoint that is used in color representing in the viewing position among the plurality of viewpoints have values less than a predetermined value.

4. The multi-view display system of claim 1, wherein the pixel value determining unit determines the pixel value of the sub-pixel based on a contribution level of a central viewpoint of the sub-pixel and a contribution level of a central viewpoint of another sub-pixel that represents a same color as a color represented by the sub-pixel.

5. The multi-view display system of claim 1, wherein the same number of sub-pixels as a number of the plurality of viewpoints form a unit block used to represent a single point of an image, and
wherein different viewpoints are used as central viewpoints of all the sub-pixels in the unit block.

6. The multi-view display system of claim 1, wherein the viewing position is determined based on a sensing result of a sensor tracking a position of eyes of the user.

7. The multi-view display system of claim 1, further comprising:
a sensor to track a position of an eye of the user.

8. A multi-view display method, comprising:
providing a contribution level for each of a plurality of viewpoints; and
determining a pixel value of a sub-pixel based on the provided contribution level, wherein the contribution level is determined based on a viewing position of a user.

9. The multi-view display method of claim 8, wherein the providing comprises calculating the contribution level based on an intensity of a signal for each of the plurality of viewpoints based on the viewing position.

10. The multi-view display method of claim 8, wherein contribution levels of viewpoints other than a viewpoint that is used in color representing in the viewing position among the plurality of viewpoints have values less than a predetermined value.

11. The multi-view display method of claim 8, wherein the determining comprises determining the pixel value of the sub-pixel based on a contribution level of a central viewpoint of the sub-pixel and a contribution level of a central viewpoint of another sub-pixel that represents a same color as a color represented by the sub-pixel.

12. The multi-view display method of claim 8, wherein the same number of sub-pixels as a number of the plurality of viewpoints form a unit block used to represent a single point of an image, and
wherein different viewpoints are used as central viewpoints of all the sub-pixels in the unit block.

13. The multi-view display method of claim 8, wherein the viewing position is determined based on a sensing result of a sensor tracking a position of eyes of the user.

14. A non-transitory computer readable recording medium storing a program to cause a computer to implement the method of claim 8.

15. A multi-view display method, comprising:
providing a contribution level for each of a plurality of viewpoints;
determining a pixel value of a sub-pixel based on the provided contribution level; and rendering a sub-pixel using the determined pixel value.

16. The multi-view display method of claim 15, wherein the contribution level is determined based on a viewing position of a user.
